(19) United States
(12) Patent Application Publication
(10) Pub. No.: US 2008/0026248 A1
(43) Pub. Date: Jan. 31, 2008

(54) Environmental and Thermal Barrier Coating to Provide Protection in Various Environments

(76) Inventors: Shekar Balagopal, Sandy, UT (US); Justin Pendleton, Salt Lake City, UT (US); Akash Akash, Salt Lake City, UT (US); Kevin Kennedy, Salt Lake, UT (US)

Correspondence Address: CERAMATEC, INC., 2425 SOUTH 900 WEST, SALT LAKE CITY, UT, 84119, US

(21) Appl. No.: 11/627,233

(22) Filed: Jan. 25, 2007

Related U.S. Application Data
(60) Provisional application No. 60/762,532, filed on Jan. 27, 2006.

(51) Int. Cl. B32B 9/00; B05D 1/02; B05D 1/18; B05D 1/28; B05D 3/00; B05D 5/10; B05D 7/00; B32B 15/04

(52) U.S. Cl. 428/688; 427/307; 427/327; 427/402; 427/424; 427/427; 427/429; 427/430.1; 428/457

(57) ABSTRACT

An article and method to provide protection in various environments. The article may include a metal substrate having a first coefficient of thermal expansion, a magnesium oxide-based layer having a second coefficient of thermal expansion, and a bond layer disposed between the metal substrate and the magnesium oxide-based layer. The bond layer may include a third coefficient of thermal expansion substantially intermediate the first and second coefficients of thermal expansion to facilitate thermal compatibility between the metal substrate and the magnesium oxide-based layer. Further, the magnesium oxide-based layer may be substantially non-porous, thereby providing a hermetic seal limiting gases, particulates, steam and fluid access to the metal substrate.

### RELATED APPLICATIONS

This application claims priority to U.S. Provisional Patent No. 60/762,352 filed on Jan. 25, 2006 and entitled ENVIRONMENTAL BARRIER COATINGS.

### U.S. GOVERNMENT RIGHTS

This invention was made in part with government support under Grant No.: DEFG-0203ER83620 awarded by the United States Department of Energy. The Government has certain rights in the invention.

### BACKGROUND OF THE INVENTION

1. Field of the Invention

This invention relates to environmental barrier coatings for metal substrates and, more particularly, to environmental barrier coatings for protecting metal or ceramic in high-temperature or corrosive or embrittling environments.

2. Description of the Related Art

Integrated Gasification Combined Cycle (“IGCC”) systems show tremendous potential for very efficient, environmentally-friendly power generation. Further, IGCC systems appear to provide the lowest cost long-term option for the reduction of carbon dioxide emissions through capture and storage.

IGCC technology couples a gasification process with a gas turbine combined cycle unit to derive high rates of efficiency with low emissions. Heavy petroleum residues, coal with high sulfur content, and even biomass are possible feeds for the gasification process. Synthesis gas, or “syngas,” produced thereby is used to drive a gas turbine to generate electricity, while resulting exhaust gases are used to generate steam. The steam is used to drive a steam turbine that, in turn, generates additional electricity.

IGCC power output and operating efficiencies increase with system operating temperature. While first generation IGCC systems were able to clean the syngas to very pure levels using low temperature processes, second generation systems designed to maximize output and operating efficiencies tend to be less effective in removing impurities. Suboptimal materials performance and stability in high-temperature syngas environments are the primary obstacles to widespread use of IGCC systems today.

The turbines used in IGCC systems are typically designed to operate with natural gas, the purest of gaseous fuels. As a result, even trace amounts of impure particulate matter such as sulfur, sodium, potassium, and other coal ash impurities pose a high risk of damage to the blade materials. Such contaminants can build up, erode, embrittle and/or corrode the turbine blades, leading to increased operating costs, both in terms of replacement blades and associated down time, as well as reduced operating efficiency.

Environmental barrier coatings (“EBCs”) have been developed to protect alloy components that are under thermal and environmental attack in harsh environments. EBCs are useful to protect alloy components in gas turbine systems, fuel cells, and plasma and gas reformer systems, and may also have application in chemical, petrochemical, catalytic, medical, municipal, airfoil and other industries. Such coatings, however, are vulnerable to cracking and delamination as a result of thermal cycling and thermal gradients existing between the EBC and the base alloy. Further, known EBCs tend to demonstrate an inherent porosity that permits access to gases and water vapor, either or both of which may contribute to coating failure. These problems are often exacerbated in an IGCC system, where EBCs are exposed to a high temperature, wet reducing environment and to impurities typical of coal-derived syngas.

In view of the foregoing, what is needed is a high-performance environmental barrier coating to protect alloy components in various environments. Beneficially, such an environmental barrier coating would demonstrate improved corrosion resistance in a reducing and oxidizing environment, enhanced bonding with a base alloy, increased thermo-mechanical and thermo-chemical compatibility with a base alloy, increased thermo-chemical and thermo-mechanical stability from exposure to ambient and hot gases, and decreased costs of manufacture. Such environmental barrier coatings are disclosed and claimed herein.

### SUMMARY OF THE INVENTION

The present invention has been developed in response to the present state of the art, and in particular, in response to the problems and needs in the art that have not yet been fully solved by currently available environmental barrier coatings. Accordingly, an environmental barrier coating has been developed that demonstrates high performance protection in various environments.

In one embodiment in accordance with the invention, an article with a protective coating to resist corrosion in a high-temperature aqueous environment includes a solid substrate, at least one magnesium oxide-based layer, and a bond layer disposed there between. In one embodiment, the substrate is metal. In another embodiment, the substrate may be ceramic. A gradient of coefficients of thermal expansion may be established between the substrate and the magnesium oxide-based layer to promote their thermal compatibility. Specifically, the metal substrate may include a first coefficient of thermal expansion, the magnesium oxide-based layer may include a second coefficient of thermal expansion, and the bond layer may include a third coefficient of thermal expansion substantially intermediate between the first and second coefficients of thermal expansion.

In certain embodiments, the metal substrate may include a ferrous metal, a non-ferrous metal, stainless steel, a metal alloy, a metal superalloy, or Haynes 230® superalloy. The metal substrate may include a bonding surface that has been chemically etched, mechanically roughened, sand-blasted, and/or pre-oxidized to improve its ability to physically bond to the bond layer.

The magnesium oxide-based layer may include a dopant such as cobalt oxide, nickel oxide, zirconium oxide, cerium oxide, titanium oxide, iron-oxide or aluminum oxide. The dopant may be present in a concentration between about 0 mol % and about 20 mol %.

In certain embodiments, the magnesium oxide-based layer may include a top coat providing a hermetic seal and one or more intermediate coats subjacent the top coat, where the intermediate coats consist essentially of magnesium oxide. The top coat may include a dopant concentration to provide a gradient of coefficients of thermal expansion and transformation toughening of the base MgO oxide between the bond layer and the top coat. In some embodiments, the top coat may include cerium-doped magnesium oxide, yttrium-doped magnesium oxide, aluminum-doped magnesium oxide, zirconium-doped magnesium oxide, iron-doped magnesium oxide, nickel-doped magnesium oxide, or simply magnesium oxide.

In one embodiment, an intermediate coat includes a first intermediate coat including magnesium oxide micro-particles and a second intermediate coat substantially subjacent the first intermediate coat that includes magnesium oxide nano-particles. The entire magnesium oxide-based layer may include a depth between about one micron and about two hundred microns, and may be substantially non-porous.

The bond layer may include lanthanum oxide-doped magnesium oxide, cerium magnesium oxide, titanium oxide-doped magnesium oxide, cerium oxide, iron oxide, nickel oxide, copper oxide, magnesium oxide, titanium oxide, aluminum oxide, nickel oxide-doped magnesium oxide, zirconium oxide, iron oxide-doped magnesium oxide, copper oxide-doped magnesium oxide, strontium oxide-doped magnesium oxide, zirconium oxide-doped magnesium oxide, cerium oxide-doped magnesium oxide, aluminum oxide-doped magnesium oxide, titanium oxide-doped magnesium oxide and/or nickel-doped magnesium oxide. The bond layer may be in the form of a green solution or green material prior to sintering and may be in the form of a nitrate solution, a colloidal suspension, or slurry of the aforementioned metal oxides, and may further include a binding agent or surfactant.

A method to protect a ceramic or metal substrate from corrosion in a high-temperature aqueous environment is also presented. In one embodiment, the method includes providing a metal substrate having a first coefficient of thermal expansion, providing one or more magnesium oxide-based layers having a second coefficient of thermal expansion, and selecting a bond layer having a third coefficient of thermal expansion substantially intermediate to the first and second coefficients of thermal expansion. The method further includes coating the metal substrate with the suspension of bond layer material by, for example, dip-coating, brush-coating, spraying, spin-coating, or wetting. In some embodiments, the method also includes sintering the bond layer. The suspension of magnesium oxide-based layer may then be applied to the bond layer, also by dip-coating, brush-coating, spraying, spin-coating, or wetting, and in certain embodiments, may also be sintered.

In certain embodiments, coating the metal substrate in accordance with embodiments of the present invention may further include preparing a bonding surface of the metal substrate to increase physical bonding between the metal substrate and the bond layer. The bonding surface may be prepared by chemical etching, mechanical roughening, sand blasting, chemically cleaning, ultrasonification and/or pre-oxidizing the bonding surface.

The features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through the use of the accompanying drawings, in which:

FIG. 1 is a cross-sectional view of an article including a substrate, bond layer, and magnesium oxide-based layer in accordance with embodiments of the present invention;

FIG. 2 is a photograph of the article of FIG. 1;

FIGS. 3A and 3B are graphical representations of thermodynamic calculations pertinent to the stability of magnesium oxide under conditions similar to those encountered in coal-derived syngas environments;

FIGS. 4A and 4B are cross-sectional views of alternative embodiments of an article in accordance with the present invention;

FIG. 5 is a flow chart illustrating a method for protecting a metal substrate in accordance with certain embodiments of the present invention;

FIG. 6 is a graph depicting relative coefficients of thermal expansion over a range of temperatures for a Haynes 230® superalloy substrate, a nickel oxide bond layer, and a magnesium oxide layer; and

FIG. 7 is a flow chart detailing a process for making an article resistant to corrosion and embrittlement in various environments in accordance with certain embodiments of the invention.

FIG. 8 is a flow chart depicting a method for manufacturing nano-sized oxide materials for implementation in the ceramic oxide-based layer in accordance with the present invention.

### DETAILED DESCRIPTION OF THE INVENTION

It will be readily understood that the components of the present invention, as generally described and illustrated in the Figures herein, could be arranged and designed in a wide variety of different configurations. Thus, the following more detailed description of the embodiments of article in accordance with the present invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

As used herein, the term “coefficient of thermal expansion” or “CTE” refers to the linear coefficient of thermal expansion, a mathematical ratio of fractional linear dimensional change of a material relative to the change in temperature of the material, and is (often) reported in terms of ppm/° C. The term “magnesium oxide-based layer” refers to a composition having magnesium oxide as a primary component.

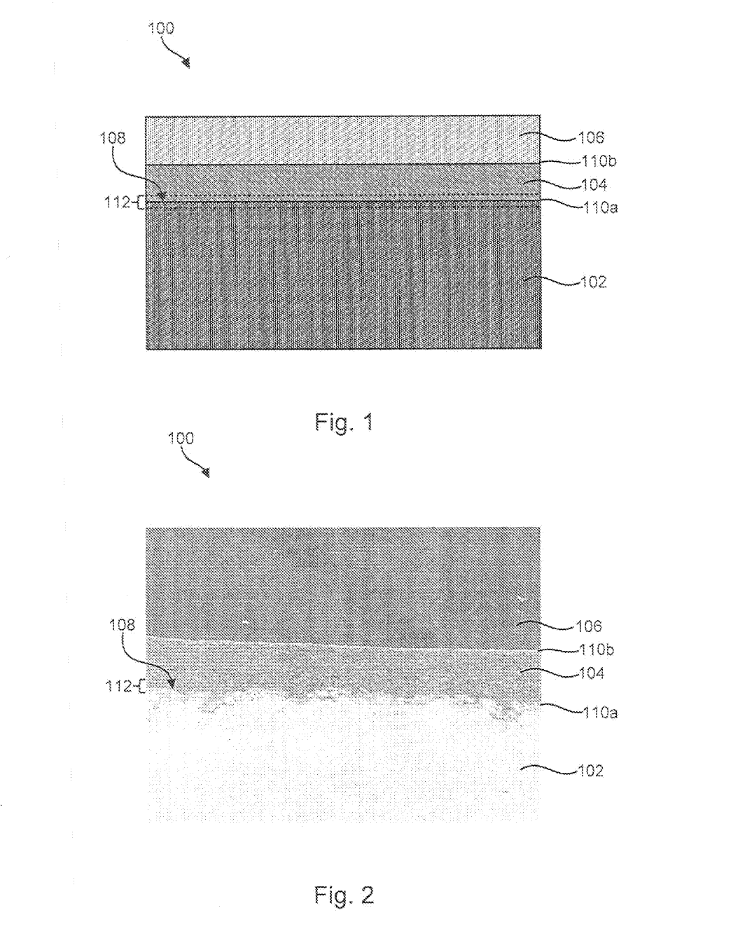

Referring now to FIGS. 1 and 2, an article 100 in accordance with embodiments of the present invention may include a solid substrate 102, a bond layer 104, and a magnesium oxide-based layer 106. The solid substrate 102 may be metal, ceramic, or some other heat-tolerant material. The metal substrate 102 may include a ferrous or non-ferrous metal, stainless steel, a metal alloy, a metal superalloy, a nickel-based superalloy such as Haynes 230® superalloy, or the like. The metal substrate 102 may be substantially planar, or may comprise any two or three-dimensional geometry. In some embodiments, the metal substrate 102 may comprise a metal component in a gas turbine, steam turbine, or Integrated Gas Combined Cycle system. In other embodiments, the metal substrate 102 may comprise a metal component used in any chemical, petrochemical, catalytic, medical, municipal, airfoil, fuel cells or other application or industry subject to a high-temperature corrosive environment known to those in the art.

In certain embodiments, the metal substrate 102 may include at least one bonding surface 108 adapted to receive a bond layer 104. The bonding surface 108 may be prepared to receive the bond layer 104 by chemical etching, mechanical roughening, sand-blasting, pre-oxidizing, or by any other means known to those in the art. In other embodiments, the boding surface 108 may be prepared by chemical cleaning or ultrasonification. Usually a substrate is contaminated with oils, debris, and dirt which needs to be cleaned or prepared before a coating can be applied. In one embodiment, this is accomplished by chemically cleaning the surface. Chemical cleaning involves soaking the substrate in a soapy bath solution with heating and agitation. The bath can be heated to about 50° C. The agitation helps in removing the contamination. The soapy bath can also be in an ultrasonic bath. This will also help in agitation and at the same time remove particles and debris from the substrate. After the cleaning the substrate is rinsed off in either alcohol or clean water. It is preferred to clean off the substrate with alcohol or water. In another embodiment, the substrate is placed in an ultrasonic bath. The ultrasonic bath helps remove any solutions that may be on the substrate, including any left over solutions the may be left by applying the bond surface preparation and/or cleaning methods discuss above. It will be appreciated by those of skill in the art that regular rinsing my leave residual cleaning solutions on the substrate, whereas ultrasonification or ultrasonic cleaning does not.

In this manner, physical bonding between the metal substrate 102 and the bond layer 104 of the present invention may be increased to reduce an incidence of spallation or delamination of the bond layer 104 from the metal substrate 102.

An interface 110a between the metal substrate 102 and the bond layer 104 may be further stabilized by the formation of a protective oxide scale 112 there between. The protective oxide scale 112 may be produced by cations diffusing outwardly from the metal substrate 102 and oxygen diffusing inwardly from the bond layer 104 toward the grain boundary interface 110a. This chemical interaction is dependent, however, on inherent properties of both the metal substrate 102 and the bond layer 104. Accordingly, the extent to which the protective oxide scale 112 operates to stabilize the interface 110a between the metal substrate 102 and the bond layer 104 depends on the chemical make-up of both the metal substrate 102 and bond layer 104.

Without being limited to any one theory, it is thought that in some instances selection of a specific metal substrate 102 and an appropriate bond layer 104 requires a determination of whether the substrate 102 is a ferrous or non ferrous metal. For non-ferrous metals such as nickel-based superalloy, a bond coat 104 such as nickel oxide or copper oxide may be used based on chemical compatibility, solubility, and coefficient of thermal expansion compatibility with the substrate 102. As a chemical reaction occurs between the bond coat 104 and the substrate 102 during sintering in air, argon, nitrogen, or hydrogen at a temperature between about 400° C. and about 1200° C., for example, a Ni—Cr—NiO— MO where (MO=metal oxide) type chemistry/phase may form predominantly at the substrate 102-bond coat 104 interface 110a, creating a stable oxide scale. This oxide scale may maintain the interface 110a at equilibrium when exposed to aggressive turbine or corrosive conditions at elevated temperatures, such as temperatures greater than about 1000° C.

Where the substrate 102 comprises a ferrous metal such as iron or chromium dominated alloys such as stainless steel, on the other hand, bond coat 104 materials such as nickel oxide, iron oxide, cerium oxide or lanthanum oxide-doped magnesium oxide may be appropriate, based on chemical compatibility, solubility, and coefficient of thermal expansion compatibility with the substrate 102. It is believed that as a reaction occurs between the bond coat 104 and the ferrous substrate 102 during sintering in air, argon, nitrogen or hydrogen at temperatures between about 400° C. and about 1200° C., for example, a Fe—Cr—Fe₂O₃— with magnesium oxide with metal oxide do pant type phase may form predominantly at the substrate 102-bond coat 104 interface 110a, creating a stable oxide scale. This oxide scale may maintain the interface 110a at equilibrium when exposed to aggressive turbine or corrosive conditions at elevated temperatures, such as temperatures greater than about 1000° C.

In certain embodiments, the bond layer 104 may comprise an oxide-based under-layer that (1) forms a stable metal oxide scale 112 on the bonding surface 108 of the metal substrate 102, (2) provides a strong chemical bond with elements in the metal substrate 102, (3) establishes a well-bonded interface 110b between the bond layer 104 and the magnesium oxide-based layer 106, and (4) provides thermal expansion grading between the metal substrate 102 and the bond layer 104 to limit interfacial stresses, as discussed in more detail below. As previously mentioned, possible bond layer 104 candidates may include, for example cerium oxide-doped magnesium oxide, iron oxide, nickel oxide, copper oxide, magnesium oxide, titanium oxide and aluminum oxide.

In some embodiments, the bond layer 104 may further comprise a dopant in a concentration up to about 10 mol %. Thus, in some embodiments the bond layer 104 may comprise, for example, nickel oxide-doped magnesium oxide, zirconium oxide-doped magnesium oxide, cerium oxide-doped magnesium oxide, aluminum oxide-doped magnesium oxide, or nickel-doped magnesium oxide. The suspension used for applying the bond layer 104 may further include a binding agent, such as Poly Vinyl Buterol, and/or a surfactant, such as Igepal CO520. The carrier liquid of suspension or slurry may include organic solvents such as ethyl alcohol, methyl alcohol, acetone, toluene, proponal etc, and also water based.

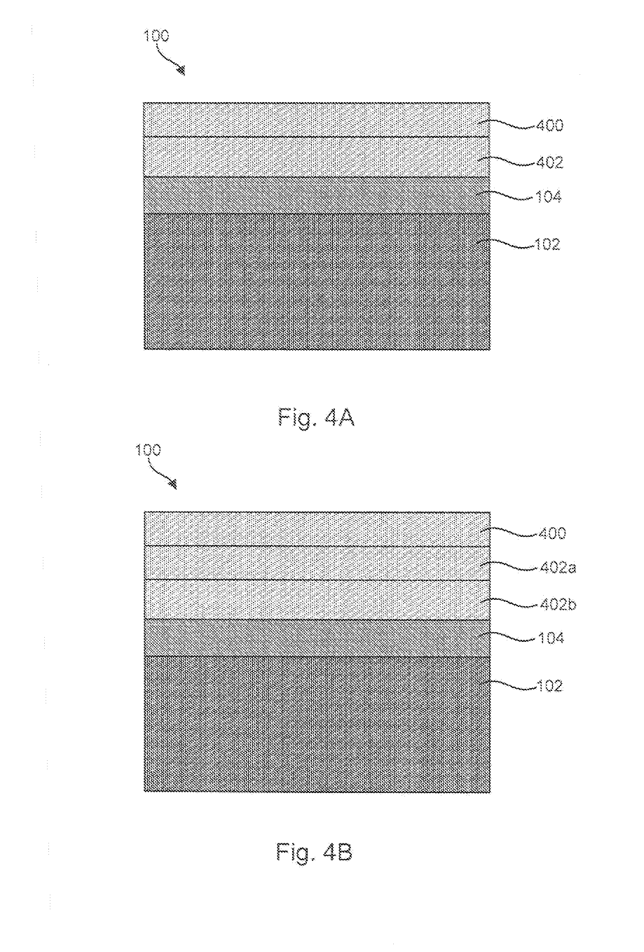

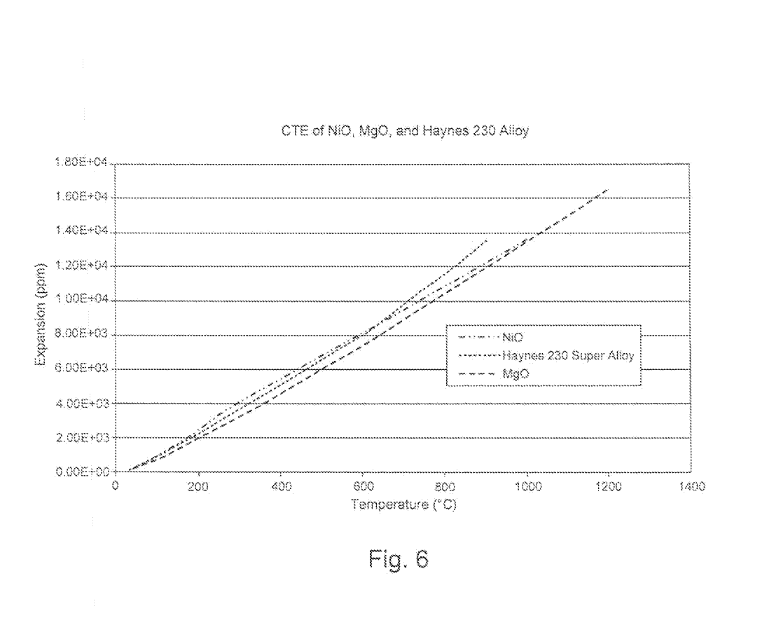

The bond layer 104 may, in its green form, take the form of a nitrate sol, a colloidal suspension, or slurry. In certain embodiments, as discussed in more detail with reference to FIGS. 4 and 6 below, the bond layer material 104 may be applied to the metal substrate 102 by dip-coating, brush-coating, spraying, spin-coating, or wetting the metal substrate 102 with the bond layer 104 material. The bond layer 104 may be sintered in an inert environment, such as air, argon, nitrogen or hydrogen, to form an adherent oxide bond layer 104.

In certain embodiments, an article 100 in accordance with the present invention includes an adherent porous bond layer 104 beneath a dense magnesium oxide-based layer 106. The thickness of magnesium oxide-based layer 106 may be built layer by layer. In some embodiments, also as discussed with reference to FIGS. 1 and 2 below, the magnesium oxide-based layer 106 may be substantially non-porous to provide a hermetic seal limiting fluid access to the metal substrate 102 through the bond layer 104.

The magnesium oxide-based layer 106 may also provide thermochemical stability with respect to ambient gases. For example, sodium, sulfur, ammonia, and other alkali and alkaline impurity components in coal and fly ash are the primary corrosive agents in an IGCC system where coal-derived syngas gas is utilized to drive gas turbines. For example, silica and silicates that easily form binary and ternary compounds with sodium and are therefore not suitable as environmental barrier coatings in an IGCC system, magnesium oxide binary oxides form no stable compounds with sodium. The particulates in coal gas fuel and ash impurities are listed below:

| Ash Composition | % of Elements |
|---|---|
| SiO₂ | 47.5 |
| Al₂O₃ | 23.6 |
| Fe₂O₃ | 0.23 |
| TiO₂ | 1.96 |
| CaO | 9.82 |
| MgO | 1.57 |
| Na2O | 2.34 |
| K₂O | 1.18 |
| SO₃ | 2.87 |

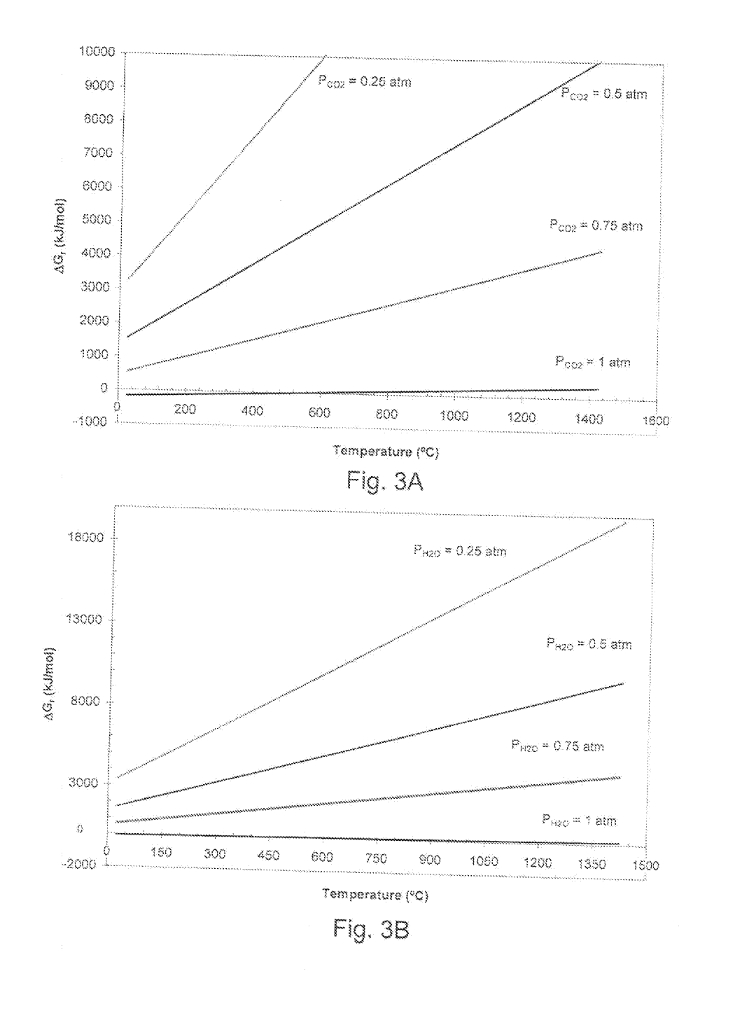

Further, magnesium oxide-based compositions may provide excellent stability in moist reducing and oxidizing environments with up to one hundred percent (100%) relative humidity. The major constituents of coal-derived syngas are hydrogen (H₂), water (H₂O), carbon monoxide (CO) and carbon dioxide (CO₂) and sulfur and ammonia. It is generally understood that the primary concerns for oxide stability are due to embrittlement and corrosion from H₂O and CO₂ Thermodynamic calculations, graphically depicted by FIGS. 3A and 3B, demonstrate the stability of magnesium oxide in CO₂ and H₂O conditions similar to those encountered in coal-derived syngas for the reactions indicated below:
MgO+CO₂→MgCO₃
MgO+H₂O→Mg(OH)₂
As shown by FIGS. 3A and 3B, the free energy of reaction of both Mg(OH)₂ and MgCO₃ by reaction of magnesium oxide with H₂O and CO₂ increases as temperature increases, and as the partial pressures of each of H₂O and CO₂ decrease. In other words, the stability of magnesium oxide increases with increased temperature and with decreased partial pressures of H₂O and CO₂. Typically, syngas compositions include between about five and about twenty percent (5%-20%) H₂O and between about two and fifteen percent (5%-15%) CO₂. As shown in FIGS. 3A and 3B, magnesium oxide is expected to be very stable under these conditions. Accordingly, the magnesium oxide-based layer 106 of the present invention may be substantially stable in an IGCC syngas environment.

### EXAMPLE 1

### Thermochemical Exposure to Syngas

Chemical stability tests in wet syngas+500 ppm of H₂S was started with a set MgO based EBC's on Haynes 230 alloy. This test was conducted at 1000° C. for 1000 hours. This was conducted to validate the chemical stability of MgO based coating of Haynes 230 super alloy.

Tests were conducted to study the weight change of alloy coupons after continues exposure to moist syngas. The coated coupons exposed to moist syngas show less than 0.5% weight gain in one case, and less than 0.4% in most cases. The as-is coupons (sand blasted, oxidized and as received) show increased weight gain when compared to the MgO based coatings. There was no evidence sulfidation reaction with MgO. This coating can also be used as an anti coking material for oxidation of hydrocarbon molecules in petrochemical applications.

### EXAMPLE 2

### Exposure of MgO Coated Alloy to Coal Gas Fuel Constituents

Preliminary corrosion stability evaluation of MgO based coatings in coal gas impurities was performed. Few elemental precursors such as SiO₂, (50.25 wt %), Al₂O₃ (24.95 wt %), Fe₂O₃ (8.7 wt %), CaO (10.38 wt %), Na₂CO₃ (3.62 wt %), and K₂CO₃ (2.1 wt %), which are typically present in coal gas fuel and ash impurities, were mixed in the form of thick paste and applied on the MgO coated alloy specimens and exposed at 1000° C. to coal ash over moist syngas for 250 hours. Cross-sectional evaluation of coated alloy specimen was performed after testing. The EBC coated alloy shows almost zero weight gain compared bare alloy which gained over 0.20% weight and SEM observation show degradation of the bare alloy, whereas the EBC coated alloy showed no adverse reaction.

### EXAMPLE 3

### Thermal Cycling of Coated Alloy Specimens in Syngas

Two alloy coupons one coated using the nano particles of MgO and the other coated using micron particles of MgO were prepared. These two along with a bare alloy coupon were thermal cycled 40 times from room temperature at 1000° C. in moist syngas environment. Both the NiO (bond coat) based MgO coatings did not show any tendency to delaminate after this test, since the CTE of NiO and MgO graded coating was well matched with that of the alloy.

In certain embodiments, the magnesium oxide-based layer 106 may include one or more dopants to improve adhesion, provide thermal grading between the metal substrate 102 and the magnesium oxide-based layer 106, and/or to improve thermochemical stability at lower temperatures than conventional ceramics, aiding with sintering of magnesium oxide based layer 106, and increasing the toughness of magnesium oxide through transformation toughening. Accordingly, the magnesium oxide-based layer 106 includes sintering aids and transformation toughening aids in the form of the dopants described throughout this specification. Suitable dopants may include, for example, cerium, yttrium, aluminum, zirconium, iron, nickel, titanium or any other suitable dopant known to those in the art.

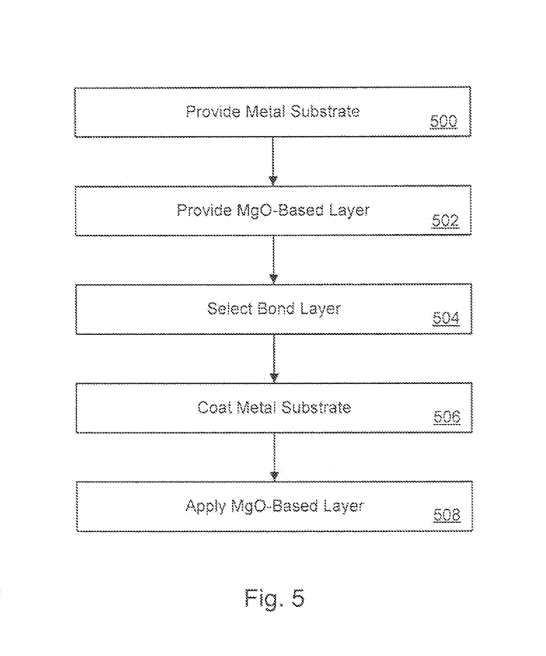

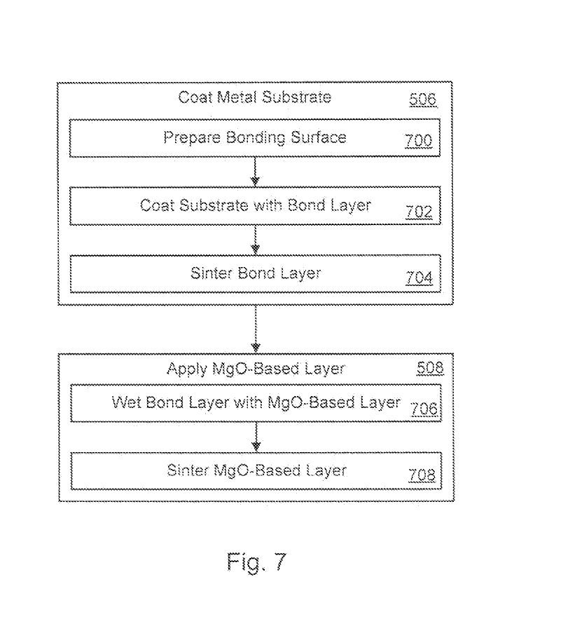

The magnesium oxide-based layer 106 of the present invention may be applied by dip-coating, brush-coating, spraying, spin-coating, or wetting the bond layer 104, as discussed in more detail with reference to FIGS. 5 and 7 below. The magnesium oxide-based layer 106 may also be sintered in an inert environment at high temperature, ranging between about 900° C. and about 1300° C., for example.

In some embodiments, coefficients of thermal expansion (“CTE”) corresponding to each of the substrate 102, the bond layer 104, and the magnesium oxide-based layer 106 may be substantially graded to permit thermal cycling across a wide temperature range, where such thermal cycling may not damage, disrupt, or separate the bond layer 104 from the substrate 102, or delaminate the magnesium oxide-based layer 106 from the bond layer 104. In one embodiment, for example, thermal expansion grading between the substrate 102 and the layers 104, 106 allows for thermal cycling across temperatures ranging from about room temperature to about 1300° C.

In certain embodiments, the substrate 102 may have a first CTE, the magnesium oxide-based layer 106 may have a second CTE, and the bond layer 104 may have a third CTE, where the third CTE is substantially intermediate the first and second CTEs. In some instances, a difference between CTEs corresponding to adjacent compositional layers 102, 104, 106 may be less than about two (2) ppm per degree Celsius. In other embodiments, a difference between CTEs corresponding to adjacent compositional layers 102, 104, 106 may be between about one-half (0.5) and about one (1) ppm per degree Celsius. Closely grading the CTEs of the substrate 102, bond layer 104, and magnesium oxide-based layer 106 in this manner may alleviate stresses otherwise resulting at interfaces 110a, 110b between the layers 102, 104, 106 due to changes in temperature.

Referring now to FIGS. 4A and 4B, some embodiments of the magnesium oxide-based layer 106 may include a top coat 400 and at least one intermediate coat 402a, 402b. The top coat 400 may provide a hermetic seal limiting fluid access to the substrate 102 through the bond layer 104. One or more intermediate coats 402a, 402b may lie subjacent to the top coat 400 to optimize thermal grading and chemical compatibility between the metal substrate 102 and top coat 400, and to enable the magnesium oxide-based layer 106 to demonstrate increased density. Increased density of the magnesium oxide-based layer 106 provides no access pathway to gases or particulates and increased protection for the article 100 from corrosive environments, in addition to providing increased abrasion resistance under operating conditions. In certain embodiments, the top coat 400 may comprise magnesium oxide as a primary, but not necessarily sole component, while the intermediate coat 402a, 402b may consist essentially of magnesium oxide.

In one embodiment, as depicted by FIG. 4A, the article 100 comprises a metal substrate 102, a bond layer 104, and a magnesium oxide-based layer 106 having a top coat 400 and an intermediate coat 402. The bond layer 104 comprises nickel oxide, while both the top coat 400 and the intermediate coat 402 comprise magnesium oxide. The top coat 400, however, comprises magnesium oxide nano-particles, while the intermediate coat 402 comprises magnesium oxide micro-particles. As used throughout this application, “nano-particles” or “nano-sized particles” are particles having an average diameter of between about 1 nanometer and about 100 nanometers. As also used throughout this application, “micro-particles” “micron-particles” “micron-sized particles” “micro-sized particles” are particles having an average diameter of between about 0.1 microns and about 20 microns. The terms “nano” “micro” and “micron” refer to the ranges set forth above. In an alternative embodiment, as depicted by FIG. 4B, the article comprises a metal substrate 102, a bond layer 104, and a magnesium oxide-based layer having a top coat 400, a first intermediate coat 402a, and a second intermediate coat 402b. The top coat 400 comprises nano-particles of cerium-doped magnesium oxide, the first intermediate coat 402a comprises nano-particles of magnesium oxide, and the second intermediate coat 402b comprises micro-particles of magnesium oxide. Other embodiments are also contemplated by the present invention. For example, in certain embodiments, the top coat 400 may comprise yttrium-doped magnesium oxide, aluminum-doped magnesium oxide, zirconium-doped magnesium oxide, iron-doped magnesium oxide, nickel-doped magnesium oxide, titanium doped-magnesium oxide and/or any other magnesium oxide-based composition known to those in the art. The composition and particle size of the intermediate coats 402a, 402b may also vary. For example, the first intermediate coat may be predominantly nano-sized particles with some micro-sized particles and the second intermediate coat could be predominantly micro-sized particles with some nano-sized particles, or vice versa.

Referring now to FIG. 5, a method to protect a metal substrate 102 in accordance with certain embodiments of the present invention may include providing 500 a metal substrate 102, providing 502 one or more magnesium oxide-based layers 106, and selecting 504 a bond layer 104 to provide graded thermal expansion between the metal substrate 102 and the magnesium oxide-based layers 106. The method may further include coating 506 the metal substrate 102 with the bond layer 104 and applying 508 the magnesium oxide-based layers 106 to the bond layer 104.

As in the article 100, the metal substrate 102 may comprise a ferrous or non-ferrous metal, a metal alloy, a metal superalloy, or any other suitable metal substrate 102 known to those in the art. Also like the article 100, the metal substrate 102 may include a first coefficient of thermal expansion. The magnesium oxide-based layer 106 may include a second coefficient of thermal expansion, and the bond layer 104 may include a third coefficient of thermal expansion that is substantially intermediate the first and second coefficients of thermal expansion. Where more than one magnesium oxide-based layer 106 is applied to the bond layer 104, any of the magnesium oxide-based layers 106 may include a unique coefficient of thermal expansion to provide graded thermal expansion between the metal substrate 102 and that layer 106.

Because coefficients of thermal expansion are temperature-dependent intrinsic property of materials, however, the third coefficient of thermal expansion may be intermediate the first and second coefficients of thermal expansion over a range of temperatures, between about ambient temperature and about 1300° C. as shown in FIG. 6. For example, the co-efficient of linear thermal expansion of Haynes metal is higher which puts the coating under compressive stress. By providing an intermediate coating layer, the coating compositions may provide graded thermal expansion between the metal substrate 102 and the magnesium oxide-based layers 106, which relieves stress over a particular temperature range.

Selecting a specific EBC compositions and the underlying bond layer for specific alloy compositions depends on the chemical composition of the substrate. Without being limited to any one theory, it is thought that in some instances, the basic criteria for selection of specific alloy composition is based on whether the chemistry of alloy/metal composition is ferrous or non ferrous. For Ni based super alloys which are rich in Ni, Fe and Cr, bond coat materials such as NiO and CuO was chosen based on chemical compatibility, solubility and CTE compatibility with the alloy. As the reaction occurs between the bond coat material and alloy during sintering in air, argon, nitrogen or hydrogen from 400° C. to 1200° C., a Ni—Cr—NiO type phase forms predominantly at the metal-bond coat interface which creates a stable oxide scale at that interface which will maintain the interface at equilibrium when exposed to aggressive turbine or corrosive condition at elevated temperatures (>1000° C.). Based on the surface analysis of coatings under the SEM/EDS microscope, the MgO coating with micron particles on CuO or NiO bond coat has shown the best bonding to alloy surface.

On Fe and Cr dominated alloy such as stainless, bond coat materials such as NiO, Fe₂O₃, CeO2, La₂O₃ was chosen as bond coat materials based on chemical compatibility, solubility and CTE compatibility of oxides will the alloy. It is believed that as the reaction occurs between the bond coat material and stainless steel (Fe rich composition) during sintering in air, argon, nitrogen or hydrogen from 400° to 1200° C. a Fe—Cr—Fe₂O₃ type phase, for example, forms predominantly at the metal-bond coat interface which creates a stable oxide scale at that interface which will maintain the interface at equilibrium when exposed to aggressive turbine or corrosive condition at elevated temperatures (>1000° C.). Thermal expansion of super alloy range from 14 to 16 ppm with thermal stability up to 1300° C. Thermal expansion of mild steel (stainless) is in the 12 to 14 ppm range with thermal stability up to 1000° C.

Referring now to FIG. 7, coating 506 a metal substrate 102 in accordance with methods of the present invention may include preparing 700 a bonding surface of the metal substrate 102, coating 702 the substrate 102 with the bond layer 104, and, in some embodiments, sintering 704 the bond layer 104. Preparing 700 a bonding surface of the metal substrate 102 may include chemically etching, mechanically roughening, sand blasting, pre-oxidizing or preparing the bonding surface by any other means known to those in the art to increase physical bonding between the substrate 102 and the bond layer 104. The prepared bonding surface of the metal substrate 102 may then be coated 702 by dip-coating, brush-coating, spraying, spin-coating, or wetting the substrate 102 with the bond layer 104. In some embodiments, the green bond layer 104 may comprise a slurry or solvent or water-based suspension enabling application of the bond layer 104 by dip-coating, thereby facilitating application of the bond layer 104 on a substrate 102 having a non-planar, tubular, three-dimensional, or other complex geometry. The bond layer 104 may then be sintered 704 at a sintering temperature in a range between about 600° C. and about 1300° C., for example.

Applying 508 the magnesium oxide-based layer 106 to the bond layer 104 may include wetting 706 the bond layer 104 with the magnesium oxide-based layer 106 by, for example, dip-coating, brush-coating, spraying, spin-coating, or by any other method known to those in the art. As with coating 702 the substrate 102, wetting 706 the bond layer 104 with the magnesium oxide-based layer 106 by dip-coating may facilitate wetting 706 a substrate 102 having a non-planar, three-dimensional, or other complex geometry. In one embodiment, the magnesium oxide-based layer 106 may have a depth of between one and two hundred microns. In another embodiment, the magnesium oxide-based layer 106 may have a depth of between three and sixty microns. In another embodiment, the magnesium oxide-based layer 106 may have a depth of between ten and twenty microns.

Wetting 706 the bond layer 104 with the magnesium oxide-based layer 106 may further include successively applying multiple magnesium oxide-based layers 106 to the bond layer 104, layer by layer, to create a dense, high purity microstructure. In one embodiment, the bond layer 104 may be successively dip-coated with multiple magnesium oxide-based layers 106 to facilitate a denser coating while reducing residual stresses. In this embodiment, the hold time in the solution, suspension viscosity, plane of dipping, and withdrawal rate may determine the quality, thickness, uniformity and green bonding of the magnesium oxide-based layer 106.

In some embodiments, the thickness of the magnesium oxide-based layer 106 may be built layer by layer with a sintering step in between, or by application of several layers followed by an intermediate sintering step and the application of additional layers. Alternatively, application of the layers may include no intermediate sintering step.

In any case, in certain embodiments, a method in accordance with the present invention may further include sintering 708 a full density of the magnesium oxide-based layer 106. In one embodiment, for example, a sintering temperature may be between about 900° C. and about 1300° C. and a sintering time may be between about two (2) and about eight (8) hours, depending on particle size, morphology, and composition of the layers 106.

Thus, the present article, coating and method disclosed herein provided protection to metals or ceramics or other solid substrates from corrosion when exposed to dry or wet syngas chemistry. The article, coating and method also provide protection against the sulfidation of metal and allow substrates to be coke tolerant. The coatings also guard against Shift reaction of H₂O and syngas.

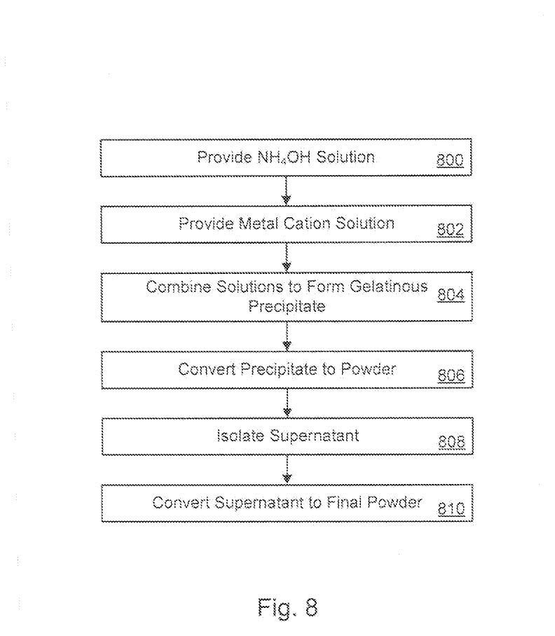

Referring now to FIG. 8, certain embodiments of a method to protect a pre-coated substrate 102 from corrosion in a wide-temperature range, wet environment include producing nano-sized oxide materials for implementation in the ceramic oxide-based layer 106. In one embodiment, for example, nano-sized particles of undoped MgO and MgO doped with, for example, ten volume percent (10 vol %) of ZrO2, CeO2 or CoO, may be produced. ZrO2 doping may be expected to increase transformation toughening of MgO, while CeO2 doping may provide chemical bonding and thermal expansion grading, and CoO doping may lower the sintering temperature of an MgO coating in an inert environment.

Producing nano-sized oxide materials in accordance with certain embodiments of the present invention may include providing 800 an ammonium hydroxide solution, providing 802 a metal cation solution 802, and combining 804 the solutions to form a gelatinous precipitate. The solutions may be combined 804 by stirring with a magnetic stirrer using a peristaltic pump. The metal cation solution may be added to the ammonium hydroxide solution at a rate of about three (3) drops per second.

Producing nano-sized oxide materials may further comprise converting 706 the precipitate to powder form. Specifically, in certain embodiments, the gelatinous precipitate may be washed in ethanol, filtered, and the solvent removed by grinding in a preheated mortar and pestle. The resulting material may be dried overnight in an oven at a temperature of about one hundred thirty degrees Celsius (130° C.). The dry cake may be calcined in a furnace at a temperature ranging from between about four hundred and about six hundred degrees Celsius (400-600° C.) for about three (3) hours to achieve the desired crystallographic phases.

To isolate 808 the supernatant, the calcined powder may be dispersed in water and ultrasonicated to remove large agglomerates (greater than about 400 nm) by decanting the top suspension and discarding the bottom solution. In one embodiment, the pH of the solution is adjusted, the solution is ultrasonicated for about nine (9) hours, and left to sit for about forty-eight (48) hours to remove agglomerates. Finally, the supernatant may be converted 810 to a final powder. Particularly, the supernatant may be dried, the soft agglomerates broken up by mortar and pestle, and then screened through a fine mesh screen to achieve the desired final powder. The final powder may be characterized according to surface area, crystallite size, particle size, agglomeration, chemical and phase purity to ensure its appropriateness for use as a component of the suspension or slurry used to apply the green ceramic oxide-based layer coating 106.

In one embodiment, synthesis of nano- and micron-sized oxide was accomplished by a standard co-precipitation method but with several modifications. The procedure followed to make individual single oxide or doped oxide compositions are described in flow chart of FIG. 8.

Nano-sized particles of undoped MgO and doped MgO (in one example) with 10 volume percent of ZrO₂ in MgO, CeO₂ in MgO and CoO in MgO were prepared by co-precipitation. In some cases ZrO₂ doping could increase transformation toughening of MgO, CeO₂ doping could provide chemical bonding and thermal expansion grading, and CoO doping could lower the sintering temperature of MgO coating in inert environment.

In the process of synthesizing MgO based nano-sized materials, stock solutions of metal cation nitrates were mixed with ammonium hydroxide solution under stirring conditions depending on single or doped oxide compositions. The gelatinous precipitate was washed in ethanol and dried. The dry cake was calcined at air furnace in the temperatures ranging from 250° C. to 600° C. to achieve the desired crystallographic phases. The calcined powder was dispersed in water and ultrasonicated to remove large agglomerates (>400 nm) by decanting the top suspension and discarding the bottom solution. The supernatant is dried and the soft agglomerates are broken up in a mortar and pestle, and then screen through a fine mesh screen to achieve the desired final powder.

Nitrate solutions, nano and micron suspensions (slurry) were prepared for applying the bond coat. An aqueous solution of the desired cation complex (precursor for the desired final oxide) is prepared by dissolving high purity nitrate crystal in de-ionized water. The pH of the solution is adjusted to maintain the stability of multiple nitrates precursors. The viscosity is adjusted based on prior experience to provide good adhesion and uniform coating. Pre-dispersed commercially available XUS binding agent will be used as a wetting agent for the alloy surface. Single or multiple coats will be applied by dip coating as per the development matrix. The coatings will be dried at temperature below 40° C. before sintering at 900° C. or below, in inert gas atmosphere (N₂, H₂, or Ar). Coatings were be fired in air to compare corrosion resistance and chemical stability.

In one embodiment, preparation of suspensions (slurries) of nano- and micron-sized MgO-based materials was accomplished by developing an organic solvent based suspension of nano- and micron-sized particles. Nano and submicron sized MgO based material was dispersed either in methyl alcohol or toluene-ethyl alcohol and other polar and non polar solvents. MgO based suspensions from 20 to 40% loading in toluene based solvent mixtures with poly vinyl butoral as a dispersant was established. The ingredients were mixed in a nalgene container with yttrium stabilized zirconium or alumina media half filled in the container. The slurry was de-aired by ultrasonic process and then flowing the slurry through a nitrogen feed to remove air bubbles. Viscosity of the solvent with loading of MgO up to 60% in the 5 to 20 cps range up to 200 cps was established. The benefits of the solvent based suspensions is discussed in the coating application and firing sections.

In parallel, effort was expended to also develop water based suspensions of nano- and micron-sized MgO and doped MgO materials. Suspensions (or slurry) of nano- and sub-micron particles of oxides were developed by performing experiments to disperse the oxide particles in a series of well known water soluble organic binders and dispersants (poly vinyl alcohol, -Darvin-C, commercially available chemical). Stable aqueous suspensions with oxide loading of 5 to 20 wt % were prepared using a commercially available Igepal-520 dispersing agent. The suspension rheology was studied by maintaining the viscosity in the 600 to 1200 cps range with 2% organics.

The coatings of MgO based suspensions were applied by automated dip coating method on the as-is or prepared surface of alloy by dipping into a solution or slurry bath filled in a beaker, and care was taken to control the speed of coater dipping and withdrawal rates at 0.4×10⁻⁴ M/s to obtain uniform green coating. The hold time in the solution, suspension viscosity and the plane of dipping of the substrates determines the quality, thickness and green bonding of as applied coatings.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. An article with a protective coating, the article comprising:
a solid substrate having a first coefficient of thermal expansion;
at least one magnesium oxide-based layer having a second coefficient of thermal expansion; and
a bond layer disposed between the substrate and the at least one magnesium oxide-based layer, the bond layer having a third coefficient of thermal expansion substantially intermediate the first and second coefficients of thermal expansion.

2. The article of claim 1, wherein the solid substrate comprises ceramic.

3. The article of claim 2, wherein the ceramic substrate comprises one of the group consisting of Alumina, Aluminum Oxide, Zirconia, Zirconium Oxide, Magnesium Oxide, Spinel, SiO₂, SIC, Si3N4, Mullite, Quartz, and combinations thereof.

4. The article of claim 1, wherein the solid substrate comprises a metal.

5. The article of claim 4, wherein the metal substrate comprises one of the group consisting of a ferrous metal, a non-ferrous metal, stainless steel, a metal alloy, a metal superalloy, and Haynes 230® superalloy.

6. The article of claim 4, wherein the metal substrate comprises at least one of a chemical-etched bonding surface, a roughened bonding surface, a sand-blasted bonding surface, and a pre-oxidized bonding surface.

7. The article of claim 4, wherein the metal substrate comprises a surface prepared by one of chemically cleaning and ultrasonification.

8. The article of claim 1, wherein the at least one magnesium oxide-based layer further comprises a dopant selected from the group consisting of cobalt oxide, nickel oxide, zirconium oxide, cerium oxide, titanium oxide, iron-oxide, and aluminum oxide.

9. The article of claim 8, wherein the dopant comprises a concentration in a range between about 0 mol % and about 20 mol %.

10. The article of claim 8, wherein the dopant has a particle size of between about 1 nanometer and about 10 microns.

11. The article of claim 1, wherein the at least one magnesium oxide-base layer is stable at temperatures in the range of between about 1° C. to about 1300° C.

12. The article of claim 1, wherein the at least one magnesium oxide-based layer comprises:
a top coat providing a hermetic seal; and
at least one intermediate coat subjacent the top coat, the at least one intermediate coat consisting essentially of magnesium oxide.

13. The article of claim 12, wherein the top coat comprises a concentration of magnesium oxide-dopant to provide a gradient of coefficients of thermal expansion between the bond layer and the top coat.

14. The article of claim 12, wherein top coat comprises a material selected from the group consisting of cerium oxide-doped magnesium oxide, yttrium oxide-doped magnesium oxide, aluminum oxide-doped magnesium oxide, zirconium oxide-doped magnesium oxide, iron oxide-doped magnesium oxide, nickel oxide-doped magnesium oxide, titanium oxide-doped magnesium oxide and magnesium oxide.

15. The article of claim 12, wherein the at least one intermediate coat comprises:
a first intermediate coat comprising magnesium oxide nano-particles; and
a second intermediate coat substantially subjacent the first intermediate coat, the second intermediate coat comprising magnesium oxide micro-particles.

16. The article of claim 1, wherein the at least one magnesium oxide-based layer comprises a depth in a range of between about three microns and about sixty microns.

17. The article of claim 1, wherein the at least one magnesium oxide-based layer comprises a depth in a range of between about one micron and about two hundred microns.

18. The article of claim 17, wherein the at least one magnesium oxide-based layer comprises a depth in a range of between about ten microns and about twenty microns.

19. The article of claim 1, wherein the at least one magnesium oxide-based layer is substantially non-porous.

20. The article of claim 1, wherein the bond layer is selected from the group consisting of lanthanum oxide-doped magnesium oxide, cerium oxide-doped magnesium oxide, titanium oxide-doped magnesium oxide, cerium oxide, iron oxide, nickel oxide, copper oxide, magnesium oxide, titanium oxide, aluminum oxide, nickel oxide-doped magnesium oxide, zirconium oxide-doped magnesium oxide, cerium oxide-doped magnesium oxide, aluminum oxide-doped magnesium oxide, nickel-doped magnesium oxide, zirconium oxide, iron oxide-doped magnesium oxide, copper oxide-doped magnesium oxide, and strontium oxide-doped magnesium oxide.

21. The article of claim 1, wherein the bond layer further comprises at least one of a binding agent and a surfactant.

22. A method to protect a metal substrate, the method comprising:
providing a solid substrate having a first coefficient of thermal expansion;
providing at least one magnesium oxide-based layer having a second coefficient of thermal expansion;
selecting a bond layer having a third coefficient of thermal expansion substantially intermediate the first and second coefficients of thermal expansion;
coating the metal substrate with the bond layer; and
applying to the bond layer the at least one magnesium oxide-based layer.

23. The method of claim 22, wherein the solid substrate comprises metal.

24. The method of claim 22, wherein the solid substrate comprises ceramic.

25. The method of claim 23, wherein coating the metal substrate further comprises preparing a bonding surface of the metal substrate to increase physical bonding between the metal substrate and the bond layer.

26. The method of claim 25, wherein preparing the bonding surface to increase physical bonding comprises at least one of chemical etching, roughening, sand blasting, and pre-oxidizing the bonding surface.

27. The method of claim 25, wherein preparing the bonding surface to increase physical bonding comprises one of chemically cleaning the surface and ultrasonification of the surface.

28. The method of claim 23, wherein coating the metal substrate comprises at least one of dip-coating, brush-coating, spraying, spin-coating and wetting the metal substrate with the bond layer.

29. The method of claim 23, wherein coating the metal substrate with a bond layer comprises dipping the metal substrate into one of a nitrate solution, a colloidal suspension, and slurry.

30. The method of claim 29, wherein the nitrate solution, colloidal suspension, and slurry comprise at least one of nano-sized particles and micron-sized particles.

31. The method of claim 23, wherein coating the metal substrate further comprises sintering the bond layer.

32. The method of claim 22, wherein applying to the bond layer the at least one magnesium oxide-based layer comprises at least one of dip-coating, brush-coating, spraying, spin-coating and wetting the bond layer with the at least one magnesium oxide-based layer.

33. The method of claim 22, wherein applying to the bond layer the at least one magnesium oxide-based layer further comprises sintering the at least one magnesium oxide-based layer.

34. The method of claim 23, wherein coating the metal substrate with the bond layer comprising sintering the coated substrate in one of air, nitrogen, hydrogen, and argon atmospheres.

35. The method of claim 22, wherein the at least one magnesium oxide-based layer comprises a sintering aid.

36. The method of claim 22, wherein the at least one magnesium oxide-based layer comprises a transformation toughening aid.

37. An article produced by the steps of:
providing a metal substrate having a first coefficient of thermal expansion;
providing at least one magnesium oxide-based layer having a second coefficient of thermal expansion;
selecting a bond layer having a third coefficient of thermal expansion substantially intermediate the first and second coefficients of thermal expansion;
coating the metal substrate with the bond layer; and
applying the at least one magnesium oxide-based layer to the bond layer.

38. The article of claim 37, wherein the at least one magnesium oxide-based layer comprises:
a top coat providing a hermetic seal; and
at least one intermediate coat subjacent the top coat, the at least one intermediate coat consisting essentially of magnesium oxide.

39. The article of claim 37, wherein the at least one magnesium oxide-based layer comprises a sintering aid.

40. The article of claim 37, wherein the at least one magnesium oxide-based layer comprises a transformation toughening aid.
